(19) United States
(12) Patent Application Publication
(10) Pub. No.: US 2019/0235361 A1
(43) Pub. Date: Aug. 1, 2019

(54) PORTABLE MULTIUSE ARTIFICIAL INTELLIGENT AND INTERACTIVE STANDALONE PROJECTOR

(71) Applicant: David Ber Shakarov, Brooklyn, NY (US)

(72) Inventor: David Ber Shakarov, Brooklyn, NY (US)

(21) Appl. No.: 16/294,018

(22) Filed: Mar. 6, 2019

(51) Int. Cl. G03B 21/10; G03B 21/56; G03B 21/12; G06F 16/955; G03B 21/14

(52) U.S. Cl. CPC G03B 21/10; G03B 21/56; G03B 21/145; G06F 16/9566; G06F 16/9558; G03B 21/12

(57) ABSTRACT

The present disclosure relates to a portable multiuse intelligent and interactive projector or image projector. An aspect of the present disclosure relates to a portable multiuse projector. The portable multiuse projector includes a processor, a memory in communication with the processor, an inbuilt display and control screen integrated at a surface of a housing of said portable multiuse projector, and an integrated browser program configured to explore one or more contents on a World Wide Web (WWW) and present said one or more contents on the inbuilt display and control screen. The inbuilt display and control screen is in communication with the processor and wherein the inbuilt display and control screen is configured to provide, in real-time, one or more inputs to the processor for generating an image or moving images and to control, in real-time, a projection of said image or said moving images onto a projection surface.

### FIELD OF DISCLOSURE

The present disclosure relates to a field of optical devices. More particularly, hut not exclusively, the present disclosure relates to a portable multiuse intelligent and interactive projector or image projector.

### BACKGROUND OF THE DISCLOSURE

A projector or image projector Is an optical device that projects an image (or moving images) onto a surface, commonly t projection screen. Most projectors create an image by shining a light through a small transparent lens, but some newer types of projectors can project the image directly, by using lasers. A virtual retinal display, or retinal projector, is a projector that projects an image directly on the retina instead of using an external projection screen.

The most common type of projector used today is called a video projector. Video projectors are digital replacements for earlier types of projectors such as slide projectors and overhead projectors. These earlier types of projectors were mostly replaced with digital video projectors throughout the 1990s and early 2000s, but old analog projectors are still used at some places. The newest types of projectors are handheld projectors that use lasers or LEDs to project images. Their projections are hard to see if there is too much ambient light. Movie theaters used a type of projector called a movie projector, nowadays mostly replaced with digital cinema video projectors.

Projectors can be roughly divided into three categories, based on the type of input. Some of the listed projectors were capable of projecting different types of input. For instance: video projectors were basically developed for the projection of prerecorded moving images, but are regularly used for still images in PowerPoint presentations and can easily be connected to a video camera for real-time input. The magic lantern is best known for the projection of Still images, but was capable of projecting moving images from mechanical slides since its invention and was probably at its peak of popularity when used in phantasmagoria shows to project moving images of ghosts.

Generally, the operation theory of projectors is similar to that of devices for displaying slides or transparencies; i.e. in both of the above-mentioned devices a high brightness/luminance light bulb is utilized as a light source, and the content to be displayed is projected on a white display curtain or a wall. In addition, because a projector provides several different image transmission interfaces, the projector can receive data transmitted by digital or analogue image sources, such as a computer or a television, and project the transmitted images on a while display curtain or a wall, enlarging the image scale and therefore enabling many people to see them. For this reason, projectors are usually utilized in large-scale meetings or home theaters. Modem projectors have become portable, and both size and price have been reduced, therefore giving them great potential in the current market.

Projectors in the current market are generally only capable of receiving images from a single image source. Even if a projector capable of connecting to different image sources simultaneously is utilized, only one image transmitted from one single image source can be displayed at any one time, meaning the user needs to control the projector to switch to different image sources to allow the different images to be seen. Different images at the same time still cannot be seen, however. To enable the user to see images from different image sources at the same lime, it is necessary to utilize an external integrating system to integrate images from different image sources into a single image, to transmit the single integrated image to the projector and then to project the single integrated image.

More companies seek efficiency products and small businesses are seeking cost-effective ways to minimize costs. Projectors used to generate enlarged images from software, or computer-genera led images are known, such as those shown in U.S. Pat. No. 5,951,136 (Furultata, et al), U.S. Pat. No. 7,396,137 B2 (Lira), and U.S. Pat. No. 7,896,503 B2 (Woo). Electronic image projection devices, such as those described in U.S. Pat. No, 6,626,543 (Denyberry), a unit with a built in display component. U.S. Pat. No. 7,771,057 B2 (Combs, et al.), or with scanning capabilities, U.S. Pat. No. 7,075.685 B2 (Chen et al.) are also known. Mobile products with multi-use features that allow employees to slay on the road to increase company productivity are needed as the competition in business grows.

However there are many technical problems that exist with the current projectors that are available in the market and the technologies used for operating the same. One of the important technical problems is that most of the projectors these days are not portable and are either controlled with a remote or with buttons on the projector or with a mobile phone. Another technical problem in the existing projectors is that does not support an integrated display to provide, in real-time, inputs for/while generating an image or moving images and to control, in real-time, a projection of said image or said moving images onto a projection surface. Yet another technical problem in the existing projectors does not include any facility or mechanism to explore one or more contents on an internet or the World Wide Web (WWW) on its own. Yet another technical problem in the existing projectors there is no provision of mirroring or screen mirroring of one or more contents of the projectors on one or more connected electronic devices.

Whereas there is certainly nothing wrong with the existing projectors nonetheless, with the growth, development and increasing demand of technically advanced projectors, there still exists a dire need of a portable multiuse intelligent and interactive projector or image projector.

### SUMMARY

This summary is provided to introduce a selection of concepts in a simplified form, in be further described below in the Detailed Description. This summary is neither intended to identity key features or essential features of the claimed subject matter, nor is it intended to be used to limit the scope of the claimed subject matter.

The present invention has been accomplished under the circumstances in view. It is the main object of the present invention to provide a portable multiuse intelligent and interactive projector or image projector that solves at lest the above recited technical problems in the conventional projectors.

In order to overcome the problems as recited in the background above and to fulfill the expectations of the technically advanced projectors, the objective of the present invention is to provide a new technically advanced and improved portable multiuse intelligent and interactive projector or image projector which is not only simple structure, convenient operation, low cost and desired, and, convenient sharing and resource sharing, interactive, without security risk and ease of use.

To achieve the above objective, the present invention can be achieved by the following technical solution:

An aspect of the present disclosure relates to a portable multiuse projector. The portable multiuse projector includes a processor, a memory in communication with the processor, an inbuilt display and control screen integrated in at least one surface of a housing of said portable multiuse projector, and an integrated browser program configured to explore one or more contents on a World Wide Web (WWW) and present said one or more contents on the inbuilt display and control screen.

The inbuilt display and control screen is in communication with the processor and wherein the inbuilt display and control screen is configured to provide, in real-time, one or more inputs to the processor for generating an image or moving images and 10 control, in real-time, a projection of said image or said moving images onto a projection surface.

In an aspect, the portable multiuse projector includes one or more computer components selected from any or combination of a CPU, an internal hard drive, a motherboard, a power supply, at least one cooling fan, a video card, a Wi-Fi card, and a network card. In another aspect, the portable multiuse projector includes the CPU, internal hard drive, and motherboard, integrated within the portable multiuse projector allows a system to access to the internet, and other applications downloaded to the hard drive, plug and play devices attached to the projector and projection of documents saved on the hard drive.

In yet another aspect, a mouse and keyboard, a personal computer, a laptop or a tablet, a mobile and any other computing device, are attached to the portable multiuse projector.

In an aspect, the portable multiuse projector includes a projection system having a light source device, a housing, an optical element that transmits light projected onto the projection surface outside of the housing, a control unit that adjusts the amount of light transmitted through the projection system, on; or more mirrors, and a focusing mechanism for projection of said image or said moving images onto these projection surface.

In an aspect, the portable multiuse projector includes a communication unit selected from at least one of a Bluetooth unit, a wireless local area network communication unit, a radio frequency communication unit, a digital video broadcast (DVB-H) communication unit, an ultra-wideband (UWB) communication unit, and an infrared communication unit, a Universal Serial Bus (USB) port, an headphone or an earphone port, and an IEEE 1394.

In an aspect the portable multiuse projector includes the one or more contents including pictures, videos, documents and web pages, are connected using hyperlinks and classified with Uniform Recourse Identifiers (URLs).

In an aspect, the portable multiuse projector includes a projection lens provided on at least one surface of the enclosure for the projection of said image or said moving images onto the projection surface.

In an aspect, the portable multiuse projector includes an ON/OFF selectable button to switch ON or switch OFF said portable multiuse projector.

In an aspect, the portable multiuse projector includes a plurality of LED indicators arranged on said the enclosure of portable multiuse projector indicating whether said portable multiuse projector is in use or not in use, the plurality of LED indicators are configured to glow if said portable multiuse projector is in use. Or switched ON.

In an aspect, the portable multiuse projector includes an artificial intelligence-powered virtual assistant configured to explore one or more contents on the World Wide Web (WWW) and present said one or more contents on the inbuilt display and control screen.

In an aspect, the portable multiuse projector includes a gesture recognition circuitry and a processing unit configured to receive one or more gestures from a user in proximity and utilize the gesture processing to process the one or more received gestures to obtain the one or more inputs. In another aspect, the portable multiuse projector includes a speech recognition circuitry and a processing unit to receive the audio/spoken instructions from the users and utilize the speech processing and natural language processing to process the instructions and provide results on the screen and on the projection surface according to predetermined settings of output.

In an aspect, an Al based processing unit in the projector, will process the content on the screen and on the projection surface and provide suggestions related to the projected content on the screen. In another aspect, the portable multiuse projector an Al based processing unit configured to process the one or more inputs provided to the inbuilt display and control screen or said image or said moving images onto the projection surface and provide suggestions associated with the one or more inputs or said image or said moving images.

In an aspect, the Al based processing unit, will consider the inputs like selection or dismissal (deselection) of the suggested content and learn about the user and make a profile. The Al based processing unit, learn from the user's previous choices and pattern and the user's profile and then further utilize it for better and filtered suggestion.

In an aspect, the portable multiuse projector includes a mirroring module configured to mirror one or more contents displayed in the inbuilt display and control screen on one or more connected electronic devices,

In an aspect, the portable multiuse projector includes the integrated browser program provides a live streaming mechanism.

In an aspect, the portable multiuse projector is a standalone device having a processing circuitry to work without the need of any other electronic computing device.

In an aspect, the portable multiuse projector includes the inbuilt display and control screen, comprises a screen size of a 3-7 inch or any other size in accordance with the size of the projector.

In an aspect, the portable multiuse projector includes at least one Internet of things (IoT) device to connect an IP network for allowing access to an internet directly using inbuilt display and control screen.

In an aspect, the shape and configuration of the portable multiuse projector will bring ease to carry and use as a standalone projection device.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIGS. 1-3 illustrate different views of the proposed exemplary portable multiuse projector, in accordance with an exemplary embodiment of the present disclosure.

FIG. 4 illustrates exemplary components utilized for implementation of the proposed exemplary portable multiuse projector in accordance with an exemplary embodiment of the present disclosure.

### DETAILED DESCRIPTION

In the following description, numerous specific details are set forth in order lo provide a thorough understanding of embodiments of the present invention. It will be apparent to one skilled in the art that embodiments of the present invention may lie practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

If the specification states a component or feature “may”, “can”, “could”, or “might” be included or have a characteristic, that particular component or feature is not required to be included or have the characteristic.

Exemplary embodiments will now lie described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the an. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles arid features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

All methods described herein can lie performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Having now fully described this invention, it will be understood to those of ordinary skill in the art that the same can be performed within a wide and equivalent range of conditions, arrangements, and other parameters without affecting die scope of the invention or any embodiment thereof. All patents and publications cited herein are incorporated by reference in their entirety.

Various terms as used herein are shown below. To the extent a term used in a claim is not defined below, it should be given the broadest definition persons in the pertinent art have given that term as reflected in printed publications and issued patents at the time of filing.

The present disclosure relates to a field of optical devices. More particularly, but not exclusively, the present disclosure relates to a portable multiuse intelligent and interactive projector or image projector.

Embodiments of the present disclosure relates to a portable multiuse intelligent and interactive projector or image projector which has a screen on it so all the internal memory and details and what you want to view can be seen and easily controlled with a 3-7 inch screen on the projector itself and a user will have the option of also controlling it remotely with your phone but the user will not feel the need to use any other electronics device with this projection device. It makes using a projector very easy,

In an exemplary embodiment the portable multiuse intelligent and interactive projector or image projector includes android based platform power bank, project videos (YouTube), project images, documents), use the internet (direct from screen), Google assistant (to control projector), built in web browser, Wi-Fi, Bluetooth, screen mirroring your, phone, live streaming (like from Skype), control features with the, phone app (android, iOS), everything on the projector will be controlled with a 3-7 inch screen on one side of the projector.

In an exemplary embodiment, the connectivity options include USB, HDMI, 3.5 MM Headphone/earphone jack.

In an exemplary embodiment, the projector can be controlled via phone or the screen on the projector or through the connection. Since the present invention is a projector. It can project documents, videos and pictures. The product will have an application for the projector. The projector will have a touch screen on it. It will have built in speaker. It will have internal memory for downloading. It will mirror everything that currently existing phone does.

In an exemplary embodiment, the screen of the projector of the present invention can be coupled with a Raspberry Pi and then the combination is connected with a projection module for projection.

In an exemplary embodiment, the projector of the present invention can impact the market where people are not looking to have projectors that are annoying to use. The projector of the present invention can be essential for people who want a projector with embedded high technology that will be super easy to use and amazing to work with in office or at home

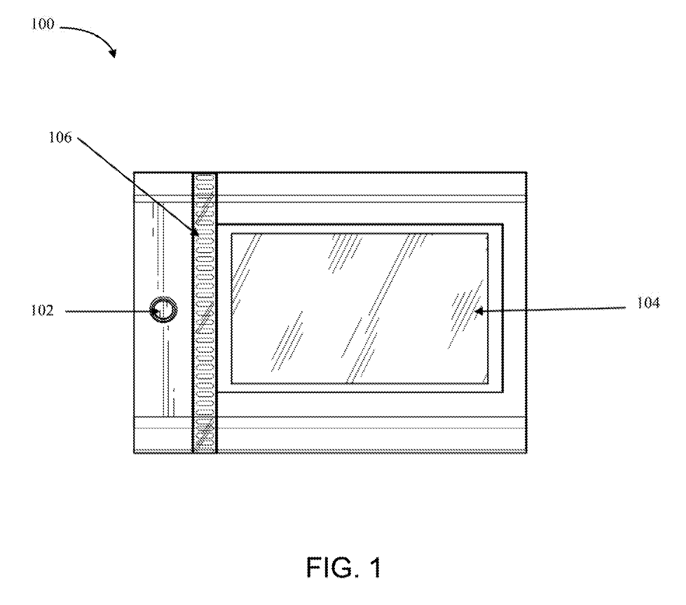

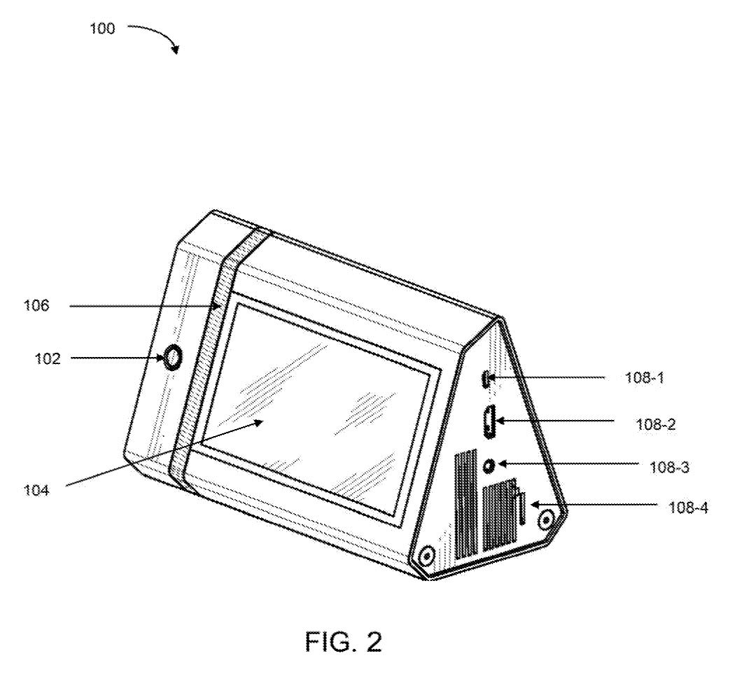

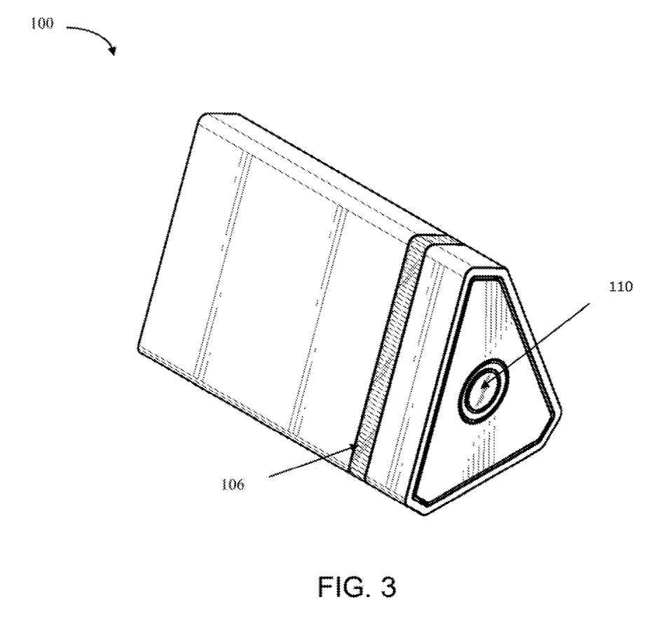

FIGS. 1-3 illustrate different views of the proposed exemplary portable multiuse projector, in accordance with an exemplary embodiment of the present disclosure.

An embodiment of the present disclosure relates to a portable multiuse projector (100). The portable multiuse projector (100) includes a processor (470), a memory (430,440) in communication with the processor (470), an inbuilt display and control screen (104) integrated in at least one surface of a housing of said portable multiuse projector (100), and an integrated browser program configured to explore one or more contents on a World Wide Web (WWW) and present said one or more contents on the inbuilt display and control screen (104).

The inbuilt display and control screen (104) is in communication with the processor (470) and wherein the inbuilt display and control screen (104) is configured to provide, in real-time, one or more inputs to the processor (470) for generating an image or moving images and to control, in real-time, a projection of said image or said moving images onto a projection surface.

In an exemplary embodiment, the portable multiuse projector (100) includes one or more computer components selected from any or combination of a CPU, an internal hard drive, a motherboard, a power supply, al least one cooling fan, a video card, a Wi-Fi card, and a network card. In another exemplary embodiment, the portable multiuse projector (100) includes the CPU, internal hard drive, and motherboard, integrated within the portable multiuse projector allows a computer to access to the internet, system applications downloaded to the hard drive, plug and play devices attached to the projector and projection of documents saved on the hard drive. In yet another exemplary embodiment, a mouse and keyboard, a personal computer, laptop or tablet computing device, are attached to the portable multiuse projector.

In an exemplary embodiment, the portable multiuse projector (100) includes a projection system having a light source device, a housing, an optical element that transmits light projected onto the projection surface outside of the housing, a control unit that adjusts the amount of light transmitted through the projection system, one or more mirrors, and a focusing mechanism for projection of said image or said moving images onto these projection surface.

In an exemplary embodiment, the portable multiuse projector (100) includes a communication units (108-1,108-2.108-3, 104-4, . . . 104-N) selected from at least one of a Bluetooth unit, a wireless local area network communication unit, a radio frequency communication unit, a digital video broadcast (DVB-H) communication unit, an ultra-wideband (UWB) communication unit, and an infrared communication unit, a Universal Serial Bus (USB) port, an headphone or an earphone port, and an IEEE 1394.

In an exemplary embodiment, the portable multiuse projector includes the one or more contents including pictures, videos, and web pages, are connected using hyperlinks and classified with Uniform Recourse Identifiers (URLs).

In an exemplary embodiment, the portable multiuse projector includes a projection lens (110) provided on at least one surface of the enclosure for projection of said image or said moving images onto the projection surface.

In an exemplary embodiment, the portable multiuse projector includes an ON/OFF selectable button (102) to switch ON or switch OFF said portable multiuse projector.

In an exemplary embodiment, the portable multiuse projector includes a plurality of light-em tiling diode (LED) indicators (106) arranged on said the enclosure of portable multiuse projector indicating whether said portable multiuse projector is switch ON or switch OFF, the plurality of LED indicators are configured to glow if said portable multiuse projector is switched ON.

In an exemplary embodiment, the portable multiuse projector (100) includes an artificial intelligence-powered virtual assistant configured to explore one or more contents on the World Wide Web (WWW) and present said one or more contents on the inbuilt display and control screen.

In an aspect, the portable multiuse projector includes a speech recognition circuitry and a processing unit to receive the audio/spoken instructions from the users and utilize the speech processing and natural language processing to process the instructions and provide results on the screen and on the projection surface according to predetermined settings of output.

In an aspect, the Al based processing unit in the projector, will process the content on the screen and on the projection surface and provide suggestions related to the projected content on the screen.

In an example, the Al based processing unit will detect the content on the display like building and architecture related content is projected using the projector and then the Al unit, will display suggestion related to other building architecture, which might be in interest of the user to view and explore.

In another example, the content related to cooking or recipe related to preparing a disk or food is projected using projector. The Al based processing unit will analyze the content and provide suggestions and recommendation based on the cooking or other recipe which might be in interest of the user.

In an aspect, the Al based processing unit, will consider the inputs like selection or dismissal (deselection) of the suggested content and learn about the user and make a profile. The Al based processing unit, learn from the user's previous choices and pattern and the user's profile and then further utilize it for better and filtered suggestion.

In an exemplary embodiment, the portable multiuse projector (100) includes a mirroring module configured to mirror one or more contents displayed in the inbuilt display and control screen on one or more connected electronic devices.

In an exemplary embodiment, the portable multiuse projector (100) includes the integrated browser program provides a live streaming mechanism.

In an exemplary embodiment, the portable multiuse projector (100) is a standalone device having a processing circuitry to work without the need of any other electronic computing device.

In an exemplary embodiment, the inbuilt display and control screen (104) comprises a screen size of a 3-7 inch or any other size in accordance with the size of the projector.

In an exemplary embodiment, the portable multiuse projector includes at least one Internet of things (IoT) device to connect en IP network for allowing access to an internet directly using inbuilt display and control screen.

In an exemplary embodiment, the portable multiuse projector (100) can include a plurality of network devices such as transmitter, receivers, and/or transceivers that may include one or more Internet of Things (IOT) devices. As used herein, an IOT device can be a device that includes sensing and/or control functionality as well as a Wi-Fi transceiver radio or interface, a Bluetooth transceiver radio or interface, a ZigBee transceiver radio or interface, an Ultra-Wideband (UWB) transceiver radio or interface, a Wi-Fi Direct transceiver radio or interface, a Bluetooth Low Energy (BLE) transceiver radio or interface, and or any other wireless network transceiver radio or interface that allows the IOT device to communicate with a wide area network and with one or more other devices. In some embodiments, an IOT device may include a cellular transceiver radio, and may be configured to communicate with a cellular network using cellular network transceiver radio. IOT devices may include home automation network devices that allow a user to access, control, and/or configure various home appliances located within user's home (e.g., a television, radio, light, fan, humidifier, sensor, microwave, iron, and/or the like), or outside of the user's home (e.g., exterior motion sensors, exterior lighting, garage door openers, sprinkler systems, or the like). Network device may include a home automation switch that may be coupled with a home appliance. In some embodiments, network devices may be used in other environments, such as a business, a school, an establishment, a park, or any place that can support a local area network to enable communication with network devices. For example, a network device can allow a user to access, control, and/or configure devices, such as office-related devices (e.g., copy machine, printer, fax machine, or the like), audio and/or video related devices (e.g., a receiver, a speaker, a projector, a DVD player, a television, or the like), media-playback devices (e.g., a compact disc player, a CD player, or the like), computing devices (e.g., a home computer, a laptop computer, a tablet, a personal digital assistant (PDA), a computing device, a wearable device, or the like), lighting devices (e.g., a lamp, recessed lighting, or the like), devices associated with a security system, devices associated with an alarm system, devices that can be operated in an automobile (e.g., radio devices, navigation devices), and/or the like.

It may be understood that the portable multiuse projector (100) may be accessed by multiple users (not shown), collectively referred to as user (not shown) hereinafter, through one or more respective computing devices (not shown), collectively referred to as user device (not shown) hereinafter, or applications residing on the computing devices (not shown). Examples of the computing devices (not shown) may include, but are not limited to, a portable computer, a personal digital assistant, a handheld device, and a workstation. The computing devices are communicatively coupled to the portable multiuse projector (100) through a network (not shown).

In one implementation, the network (not shown) may be a wireless network, a wired network or a combination thereof. The network can be implemented as one of different types of networks, such as intranet, local area network (LAN), wide area network (WAN), internet, and the like. The network may either be a dedicated network or a shared network. The shared network represents an association of different types of networks that use a variety of protocols, for example. Hypertext Transfer Protocol (HTTP). Transmission Control Protocol/Internet Protocol (TCP/IP), Wireless Application Protocol (WAP), and the like, to communicate with one another. Further, the network may include a variety of network devices, including routers, bridges, servers, computing devices, storage devices, and the like.

As used herein, the IoT devices can be a device that includes sensing and/or control functionality as well as a Wi-Fi™ transceiver radio or interface, a Bluetooth™ transceiver radio or interface, a ZigBee™ transceiver radio or interface, an Ultra-Wideband (UWB) transceiver radio or interface, a WiFi-Direct transceiver radio or interface, a Bluetooth™ Low Energy (BLE) transceiver radio or interface, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio.

A user may communicate with the network devices using an access device that may include any human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device may not include a cellular network transceiver radio or interface.

User may interact with the network devices using an application, a web browser, a proprietary program, or any other program executed and operated by the access device. In some embodiments, the access device may communicate directly with the network devices (e.g., communication signal). For example, the access device may communicate directly with network devices using ZigBee™ signals, Bluetooth™ signals, WiFi™ signals, infrared (IR) signals, UWB signals, WiFi-Direct signals, BLE signals, sound frequency signals, or the like. In some embodiments, the access device may communicate with the network devices via the gateways and/or a cloud network.

Local area network may include a wireless network, a wired network, or a combination of a wired and wireless network. A wireless network may include any wireless interface or combination of wireless interfaces (e.g., ZigBee™, Bluetooth™, WiFi™, IR, UWB, WiFi-Direct, BLE, cellular, Long-Term Evolution (LTE), WiMAX™, or the like). A wired network may include any wired interface (e.g., fiber, Ethernet, powerline, Ethernet over coaxial cable, digital signal line (DSL), or the like). The wired and/or wireless networks may be implemented using various routers, access points, bridges, gateways, or the like, to connect devices in the local area network. For example, the local area network may include gateway and gateway. Gateway can provide communication capabilities to network devices and/or access device via radio signals in order to provide communication, location, and/or other services to the devices. The gateway is directly connected to the external network and may provide other gateways and devices in the local area network with access to the external network. The gateway may be designated as a primary gateway.

The network access provided by gateway may be of any type of network familiar to those skilled in the art that can support data communications using any of a variety of commercially-available protocols. For example, gateways may provide wireless communication capabilities for the local area network using particular communications protocols, such as WiFi™ (e.g.. IEEE 802.11 family standards, or other wireless communication technologies, or any combination thereof). Using the communications protocol(s), the gateways may provide radio frequencies on which wireless enabled devices in the local area network can communicate. A gateway may also be referred to as a base station, an access point. Node B, Evolved Node B (eNodeB), access point base station, a Femtocell, home base station, home Node B, home eNodeB, or the like.

Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, die router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

The portable multiuse projector (100) can include one or more sensors,

In an exemplary embodiment, the portable multiuse projector (100) may include at least one processor, an input/output (I/O) interface and a memory. The processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory.

The I/O interface may include a variety of software and hardware interfaces, for example, a web interface, a graphical user interface, and the like. The I/O interface may allow system to interact with a user directly. The I/O interface can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server. The memory may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The memory may include modules and data. The modules include routines, programs, and objects, components, and data structures etc. which perform particular tasks or implement particular abstract data types.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

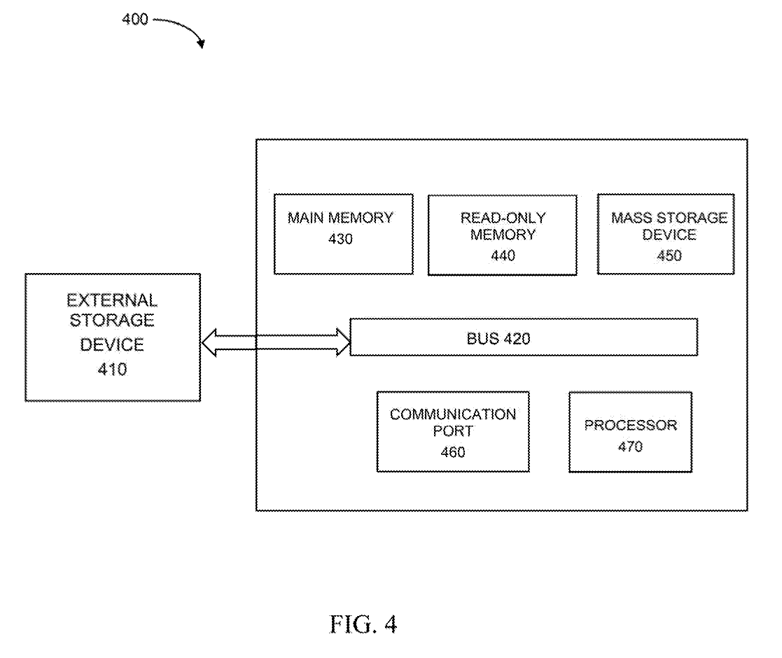

FIG. 4 illustrates exemplary components utilized for implementation of the proposed exemplary portable multiuse projector in accordance with an exemplary embodiment of the present disclosure.

As shown in the figure, the proposed exemplary portable multiuse projector (400) includes an external storage device (410), a bus (420), a main memory (430), a read only memory (440), a mass storage device (450), communication port (460), and a processor (470). A person skilled in the an will appreciate that the proposed exemplary portable multiuse projector (400) may include more than one processor and communication ports. Examples of processor (470) include, but are rot limited to, an Intel® Itanium® or Itanium 2 proccssor(s), or AMD® Opteron® or Athlon MP® processor(s), Motorola® lines of processors, FortiSOC™ system on a chip processors or other future processors. Processor (470) may include various modules associated with embodiments of the present invention. Communication port (400) can be any of an RS-232 port for use with a modem based dialup connection, a 10/100 Ethernet port, a Gigabit or 10 Gigabit port using copper or fiber, a serial port, a parallel port, or other existing or future ports. Communication port (460) may be chosen depending on a network, such a Local Area Network (LAN), Wide Area Network (WAN), or any network to which the proposed exemplary portable multiuse projector (500) connects. Memory (430) can be Random Access Memory (RAM), or any other dynamic storage device commonly known in the art. Read only memory (440) can be any static storage devices) e.g., but not limited to, a Programmable Read Only Memory (PROM) chips for storing static information e.g., start-up or BIOS instructions for processor (470). Mass storage (450) may be any current or future mass storage solution, which can be used to store information and/or instructions. Exemplary mass storage solutions include, but are not limited to, Parallel Advanced technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs. Redundant Array of Independent Disks (RAID) storage, e.g. an array of disks (e.g., SATA arrays), available from various vendors including Dot Hill Systems Corp., TaCic. Nexsan Technologies. Inc. and Enhance Technology, Inc. Bus 420 communicatively couples processors) (470) with the other memory, storage and communication blocks. Communication Bus OR Bus (420) can be. e.g. a Peripheral Component Interconnect (PCI)/PCI Extended (PCI-X) bus, Small Computer System Interlace (SCSI). USB or the like, for connecting expansion cards, drives and other subsystems as well as other buses, such a front side bus (FSB), which connects processor (470) to software system. Optionally, operator and administrative interfaces, e.g. a display, keyboard, and a cursor control device, may also be coupled to bus (420) to support direct operator interaction with computer system (400). Other operator and administrative interfaces can be provided through network connections connected through communication port (460). External storage device (410) can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

The various illustrative logical blocks, modules and circuits and algorithm steps described herein may be implemented or performed as electronic hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. It is noted that the configurations may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subrouline, a subprogram, etc. When a process corresponds to a function, its termination corresponds to a return of the function to the calling function or the main function.

When implemented in hardware, various examples may employ a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

When implemented in software, various examples may employ firmware, middleware or microcode. The program code or code segments to perform the necessary tasks may be stored in a computer-readable medium or processor-readable medium such as a storage medium or other storage(s). A processor may perform the necessary (asks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way oflocal and/or remote processes such as in accordance with a signal having one or more data packets (e.g., data from one component interacting with another component in a local system, distributed system, and/or across a network such as the Internet with other systems by way of the signal).

In one or more examples herein, the functions described may be implemented in hardware, software, firmware, or any combination thereof. If implemented in software, the functions may be stored on or transmitted over as one or more instructions or code on a computer-readable medium or processor-readable medium. A processor-readable media and/or computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in die form of instructions or data structures and mat can be accessed by a computer. One or more of the components, steps, and/or functions illustrated in the Figures may be rearranged and/or combined into a single component, step, or function or embodied in several components, steps, or functions. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device. What is claimed is:

1. A portable multiuse projector, comprising:
a processor;
a memory in communication with the processor;
an inbuilt display and control screen integrated in al least one surface of a housing of said portable multiuse projector, the inbuilt display and control screen is in communication with the processor and wherein the inbuilt display and control screen is configured to provide, in real-time, one or more inputs to the processor for generating an image or moving images and to control, in real-time, a projection of said image or said moving images onto a projection surface; and
an integrated browser program configured to explore one or more contents on a World Wide Web (WWW) and present said one or more contents on the inbuilt display and control screen.

2. The portable multiuse projector of claim 1, wherein the one or more contents including pictures, videos, and web pages, are connected using hyperlinks and classified with Uniform Recourse Identifiers (URLs).

3. The portable multiuse projector of claim 1, further comprising: an artificial intelligence-powered virtual assistant configured to explore one or more contents on the World Wide Web (WWW) and present said one or more contents on the inbuilt display and control screen.

4. The portable multiuse projector of claim 1, further comprising: a gesture recognition circuitry and a processing unit configured to receive one or more gestures from a user in proximity and utilize the gesture processing to process the one or more received gestures to obtain the one or more inputs.

5. The portable multiuse projector of claim 1, further comprising: an Al based processing unit configured to process the one or more inputs provided to the inbuilt display and control screen or said image or said moving images onto the projection surface and provide suggestions associated with the one or more inputs or said image or said moving images.

6. The portable multiuse projector of claim 1, further comprising: one or more computer components selected from any or combination of a CPU, an internal hard drive, a motherboard, a power supply, at least one cooling fan, a video card, a Wi-Fi card, and a network card.

7. The portable multiuse projector of claim 4, wherein the CPU internal hard drive, and motherboard, integrated within the portable multiuse projector allows a computer to access to the internet, system applications downloaded to the hard drive, plug and play devices attached to the projector and projection of documents saved on the hard drive.

8. The portable multiuse projector of claim 5, wherein a mouse and keyboard, a personal computer, laptop or tablet computing device, are attached to the portable multiuse projector.

9. The portable multiuse projector of claim 1, further comprising: a projection system having a fight source device, a housing, an optical element that transmits light projected onto the projection surface outside of the housing, a control unit that adjusts the amount of light transmitted through the projection system, one or more mirrors, and a focusing mechanism for projection of said image or said moving images onto these projection surface.

10. The portable multiuse projector of claim 1, further comprising: a projection lens provided on at least one surface of the enclosure for projection of said image or said moving images onto the projection surface.

11. The portable multiuse projector of claim 1, further comprising: a communication unit selected from at least one of a Bluetooth unit, a wireless local area network communication unit, a radio frequency communication unit, a digital video broadcast (DVB-H) communication unit, an ultra-wideband (UWB) communication unit, and an infrared communication unit, a Universal Serial Bus (USB) port, an headphone or an earphone port, and an IEEE 1394.

12. The portable multiuse projector of claim 1, further comprising: an ON/OFF selectable button to switch ON or switch OFF said portable multiuse projector.

13. The portable multiuse projector of claim 10, further comprising: a plurality of LED indicators arranged on said the enclosure of portable multiuse projector indicating whether said portable multiuse projector is switch ON or switch OFF, the plurality of LED indicators are configured to glow if said portable multiuse projector is switched ON.

14. The portable multiuse projector of claim 1, further comprising: a mirroring module configured to mirror one or more contents displayed in the inbuilt display and control screen on one or more connected electronic devices.

15. 1 he portable multiuse projector of claim 1, wherein the integrated browser program provides a live streaming mechanism.

16. The portable multiuse projector of claim 1 is a standalone device having a processing circuitry.

17. The portable multiuse projector of claim 1, wherein the inbuilt display and control screen comprises a screen size ranging from a 1 inch-a 7 inch.

18. The portable multiuse projector of claim 1, further comprising: at least one Internet of things (IoT) device to connect an IP network for allowing access to an internet directly using inbuilt display and control screen.
